(19) United States
(12) Patent Application Publication
(10) Pub. No.: US 2017/0338604 A1
(43) Pub. Date: Nov. 23, 2017

(54) PLUG CONNECTOR AND POWER CIRCUIT CUT-OFF DEVICE

(71) Applicant: Yazaki Corporation, Tokyo (JP)

(72) Inventors: Kenta Yasuda, Shizuoka (JP); Masaaki Iwabe, Shizuoka (JP)

(21) Appl. No.: 15/596,902

(22) Filed: May 16, 2017

(30) Foreign Application Priority Data
May 20, 2016 (JP) 2016-101839

(51) Int. Cl. H01R 13/703; H01R 13/66; H01R 13/05

(52) U.S. Cl. CPC H01R 13/7031; H01R 13/05; H01R 13/665

(57) ABSTRACT

A plug connector is provided in a plug housing and has a conductive braided wire that connects ends of a plurality of plug terminals opposite to contact points with receptacle terminals such that each plug terminal can move relatively to each other. A service plug has a plug connector and a receptacle connector.

### CROSS-REFERENCE TO RELATED APPLICATION(S)

The present application claims priority to and incorporates by reference the entire contents of Japanese Patent Application No. 2016-101839 filed in Japan on May 20, 2016.

### BACKGROUND OF THE INVENTION

### 1. Field of the Invention

The present invention relates to a plug connector and a power circuit cut-off device.

### 2. Description of the Related Art

In the background art, a power circuit cut-off device (service plug) is usually mounted on a vehicle such as an electric vehicle, a fuel cell vehicle, and a hybrid vehicle and is integrated into a power circuit for supplying electric power from a power source such as a battery to a load such as a rotary electric machine to electrically connect or disconnect the power circuit as necessary (for example, Japanese Patent Application Laid-open No. 2014-146451). The power circuit cut-off device has a plug connector and a receptacle connector. As the plug connector is engaged with the receptacle connector, the power circuit is electrically connected. As the plug connector is disengaged from the receptacle connector, the power circuit is electrically disconnected.

However, there is a demand for further improvement of the power circuit cut-off device to allow smooth insertion and removal between a terminal of the plug connector and a terminal of the receptacle connector when the plug connector is engaged with or disengaged from the receptacle connector.

### SUMMARY OF THE INVENTION

In view of the aforementioned problems, the present invention is to provide a plug connector and a power circuit cut-off device capable of smooth insertion and removal between the terminal of the plug connector and the terminal of the receptacle connector.

In order to solve the above mentioned problem and achieve the object, a plug connector according to one aspect of the present invention includes a housing engaged with or disengaged from a receptacle connector for performing electrical connection; and a plug terminal unit that is provided in the housing, and has a plurality of bar-shaped plug terminals inserted into or removed from receptacle terminals of the receptacle connector in an axial direction, and a conductive wire member that connects ends of the plurality of plug terminals opposite to contact points with the receptacle terminals such that each plug terminal can move relatively to each other, wherein the plurality of plug terminals and the wire member constitute a part of a power circuit for supplying electric power from a power source to a load along with the receptacle terminals, and the plurality of plug terminals electrically conduct the power circuit while the plug terminals are connected to the receptacle terminals.

According to another aspect of the present invention, in the plug connector, it is preferable that the wire member is a braided wire formed by braiding a plurality of metal wires or a spring stack formed by stacking a plurality of metal plates.

According to still another aspect of the present invention, in the plug connector, it is preferable that the plug terminal unit has a fastening member configured to fasten the ends opposite to contact points with the receptacle terminals to the wire member, a head portion of the fastening member is formed in a spherical surface shape, and the head portion of the fastening member abuts on an inside of the housing when the plug terminals are inserted into the receptacle terminals.

According to still another aspect of the present invention, a power circuit cut-off device includes a receptacle connector having a receptacle terminal for performing electrical connection; and a plug connector having a housing engaged with or disengaged with the receptacle connector, and a plug terminal unit that is provided in the housing and has a plurality of bar-shaped plug terminals inserted into or removed from receptacle terminals of the receptacle connector in an axial direction, and a conductive wire member that connects ends of the plurality of plug terminals opposite to contact points with the receptacle terminals such that each plug terminal can move relatively to each other, wherein the plurality of plug terminals and the wire member constitute a part of a power circuit for supplying electric power from a power source to a load along with the receptacle terminals, and the plurality of plug terminals electrically conduct the power circuit while the plug terminals are connected to the receptacle terminals.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an exploded perspective view illustrating a configuration example of a service plug according to an embodiment;

FIG. 2 is a cross-sectional view illustrating a configuration example of a receptacle connector according to the embodiment;

FIG. 3 is a cross-sectional view illustrating a configuration example of a plug connector according to the embodiment;

FIG. 4 is a front view illustrating a configuration example of a plug terminal unit according to the embodiment;

FIG. 5 is a cross-sectional view illustrating a function example of the plug connector according to the embodiment;

FIG. 6 is a cross-sectional view illustrating a function example of the plug connector according to the embodiment;

FIG. 7 is a cross-sectional view illustrating a configuration example of a plug connector according to a modification;

FIG. 8 is a front view illustrating a configuration example of the plug connector according to the modification; and

FIG. 9 is a cross-sectional view illustrating a function example of the plug connector according to the modification.

### DETAILED DESCRIPTION OF THE PREFERRED EMBODIMENTS

Aspects (embodiments) for embodying the present invention will be described in details with reference to the accompanying drawings. The present invention is not limited by the contents described in the following embodiments. In addition, elements described below include those readily conceived by a person ordinarily skilled in the art and those substantially equivalent thereto. In addition, the configurations described below may be appropriately combined. Furthermore, various omissions, substitutions, or changes for the configurations may be possible without departing from the scope and spirit of the present invention.

### Embodiment

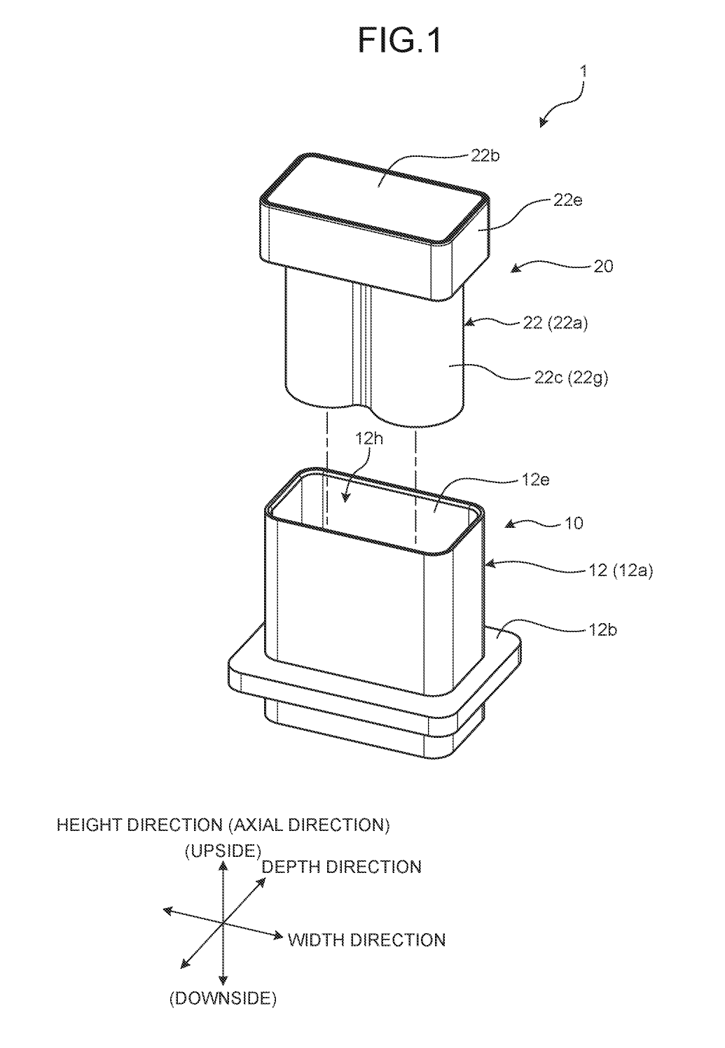

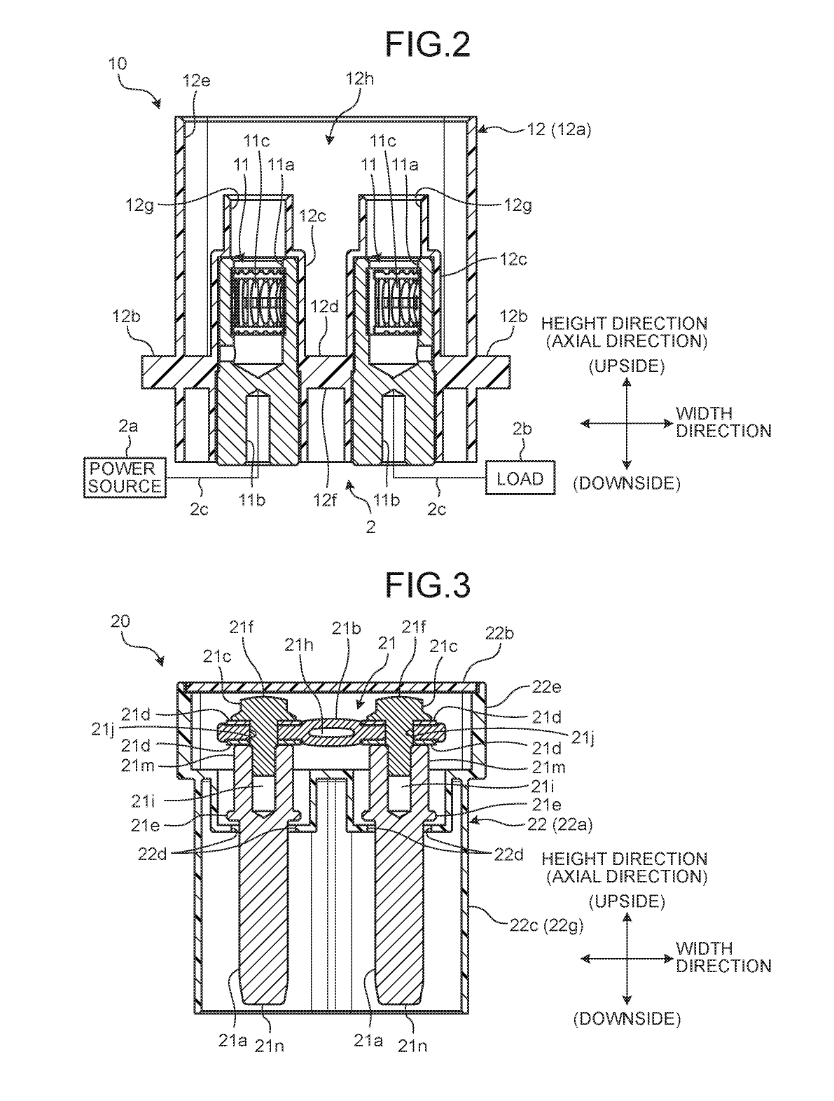

A plug connector and a power circuit cut-off device according to an embodiment will be described. In the present embodiment, as illustrated in FIG. 1, a service plug 1 serving as the power circuit cut-off device will be described by way of example. The service plug 1 is mounted on a vehicle such as an electric vehicle, a fuel cell vehicle, or a hybrid vehicle (not illustrated), and constitutes a part of a power circuit 2 for supplying electric power from a power source 2a such as a battery to a load 2b such as a rotary electric machine as illustrated in FIG. 2 to connect (electrically conduct or release disconnection) or disconnect the power circuit 2 as necessary. For example, during a work such as maintenance, the power circuit 2 is disconnected by this service plug 1 into a non-conduction state in order to secure safety of an operator by preventing an electric shock.

The service plug 1 has a receptacle connector 10 and a plug connector 20. In the service plug 1, the plug connector 20 is engaged with the receptacle connector 10 to electrically conduct the power circuit 2. In addition, the plug connector 20 is disengaged from the receptacle connector 10 to disconnect the power circuit 2.

In the following description, a direction of linking the receptacle connector 10 and the plug connector 20 (vertical direction in FIG. 1) will be referred to as a “height direction.” The side where the plug connector 20 is located will be referred to as an “upside,” and the side where the receptacle connector 10 is located will be referred to as a “downside.” In addition, a direction into which the plug connector 20 is engaged with the receptacle connector 10, that is, a downward direction of the height direction will also be referred to as an “engagement direction.” In addition, the height direction may also be referred to as an “axial direction.” Furthermore, a direction perpendicular to the height direction, in which a plurality of plug terminals 21a are arranged, will be referred to as a “width direction.” Note that the width direction includes a direction intersecting with the height direction. A direction perpendicular to the width direction and the height direction will be referred to as a “depth direction.”

As illustrated in FIG. 2, the receptacle connector 10 has a receptacle terminal 11 and a receptacle housing 12. The receptacle terminal 11 constitutes a part of the power circuit 2 along with a plug terminal unit 21 described below. The receptacle terminal 11 is a female terminal and is formed of a conductive member such as metal. A plurality of receptacle terminals 11, for example, two receptacle terminals 11 are provided. Each receptacle terminal 11 is formed in a tubular shape and is fixed to the receptacle housing 12 in the height direction. Each receptacle terminal 11 has a plug terminal insertion portion 11a and a lead portion 11b. The plug terminal insertion portion 11a is a portion where the plug terminal 21a is inserted, and is provided in an upper part in the height direction. The plug terminal insertion portion 11a has a tubular electrode member 11c formed of a plurality of spring members. The electrode member 11c is mounted along a circumferential surface of the plug terminal insertion portion 11a. When the plug terminal 21a is inserted into the plug terminal insertion portion 11a, the electrode member 11c abuts on the plug terminal 21a to electrically connect the plug terminal 21a and the receptacle terminal 11 to each other. The lead portion 11b is provided in a lower part of the height direction and is connected to the power source 2a or the load 2b of the power circuit 2 through the electric cable 2c. For example, one of the lead portions 11b of the receptacle terminal 11 is connected to the power source 2a of the power circuit 2 through the electric cable 2c, and the other lead portion 11b of the receptacle terminal 11 is connected to the load 2b of the power circuit 2 through the electric cable 2c.

The receptacle housing 12 is formed of an insulation member such as resin through injection molding to insulatively hold the receptacle terminal 11. The receptacle housing 12 has a tubular receptacle-side outer wall portion 12a, a protrusion 12b protruding from the outer circumferential surface of the receptacle-side outer wall portion 12a in the width direction, a tubular holding portion 12c provided inside the receptacle-side outer wall portion 12a in a tubular shape to hold the receptacle terminal 11, and a fixing portion 12d provided to fix the tubular holding portion 12c inside the receptacle-side outer wall portion 12a.

The receptacle-side outer wall portion 12a is formed approximately in a rectangular shape as seen from the height direction and has four arc (rounded) corners. The receptacle-side outer wall portion 12a has an opening 12e opened in an upper part of the height direction, a blocked portion 12f blocked by the fixing portion 12d in a lower part of the height direction, and an engagement cavity portion 12h partitioned by the receptacle-side outer wall portion 12a and the blocked portion 12f. The protrusion 12b is used to fix the receptacle connector 10 to a vehicle and is formed, for example, in a ring shape along a circumferential direction of the outer circumferential surface of the receptacle-side outer wall portion 12a. The tubular holding portion 12c is formed in a cavity shape extending along the height direction. A plurality of, for example, two tubular holding portions 12c are arranged along the width direction where a plurality of plug terminals 21a described below are arranged. In the tubular holding portion 12c, an opening 12g is formed in a tubular shape where the plug terminal 21a is inserted or removed, and the plug terminal 21a is guided by the opening 12g to the receptacle terminal 11.

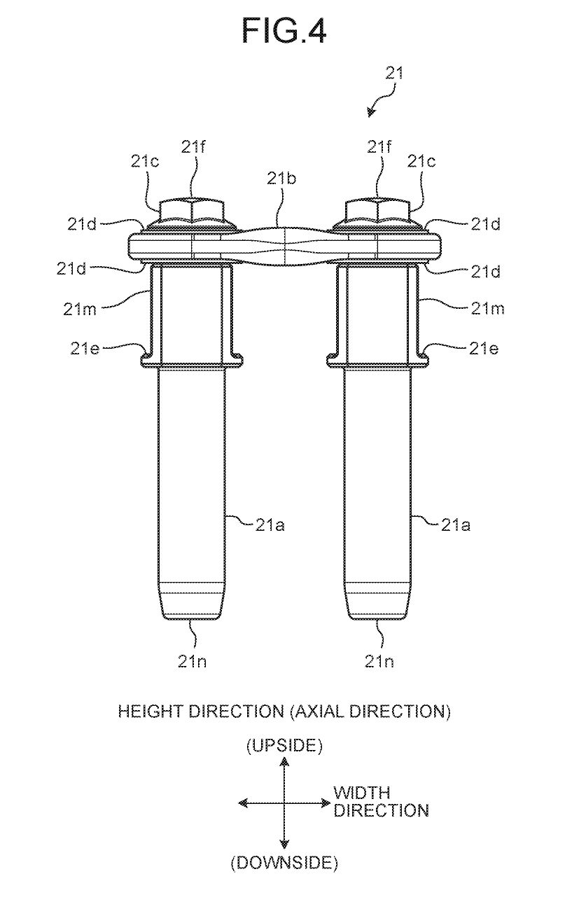

As illustrated in FIG. 3, the plug connector 20 has a plug terminal unit 21 and a plug housing 22 as a housing. As illustrated in FIG. 4, the plug terminal unit 21 has a plurality of plug terminals 21a and a braided wire 21b as a conductive wire member having flexibility higher than that of the plug housing 22. Each plug terminal 21a constitutes a part of the power circuit 2 along with the receptacle terminal 11. Each plug terminal 21a is a male terminal and is formed of a conductive member such as metal. Each plug terminal 21a is formed in a bar shape, and a plurality of, for example, two plug terminals 21a are provided. Each plug terminal 21a has the same length in the height direction and is connected to each other through the braided wire 21b to form the plug terminal unit 21. Each plug terminal 21a has a threaded hole 21i where a bolt 21c is fastened and is provided in an end 21m opposite to a contact point with the receptacle terminal 11. Each plug terminal 21a has an annular protrusion 21e abutting on a regulating portion 22d described below from the upside in the axial direction. In each plug terminal 21a, an end 21n in the side of the contact point with the receptacle terminal 11 is inserted into or removed from the receptacle terminal 11 along the axial direction (height direction).

The braided wire 21b is used to connect the ends 21m opposite to the contact points between each plug terminal 21a and the receptacle terminal 11. The braided wire 21b is formed, for example, by braiding a plurality of metal wires and has a long plate shape as seen from the height direction. The braided wire 21b has a cavity portion 21h formed in a cavity shape in the center of the width direction between each plug terminal 21a. The braided wire 21b has holes 21j in both ends where the bolts 21c are inserted. The bolts 21c are fastened to the holes 21j of both ends along with the threaded holes 21i of each plug terminal 21a to connect each plug terminal 21a. In this case, the braided wire 21b is fixed by fastening the bolts 21c to the threaded holes 21i of each plug terminal 21a by interposing washers 21d. The bolt 21c has a head portion 21f having an upper part of the height direction formed in a spherical surface shape, so that the head portion 21f abuts on the inner side of the plug housing 22 when each plug terminal 21a is inserted into each receptacle terminal 11. The plug terminal unit 21 constitutes a part of the power circuit 2 for supplying electric power from the power source 2a to the load 2b along with the receptacle terminal 11 and electrically conducts the power circuit 2 while it is connected to the receptacle terminal 11.

The plug housing 22 insulatively holds the plug terminal unit 21. The plug housing 22 is engaged with an engagement cavity portion 12h of the receptacle housing 12 or is disengaged from the engagement cavity portion 12h. The plug housing 22 has a housing body 22a and a lid portion 22b. The housing body 22a is formed of, for example, an insulation member such as resin through injection-molding and has a tubular plug-side outer wall portion 22c and a regulating portion 22d.

The tubular plug-side outer wall portion 22c forms an outer wall of the housing body 22a and has an exposed portion 22e gripped by an operator and a plug engagement wall 22g where the receptacle housing 12 is engaged. The exposed portion 22e is a portion where the plug housing 22 is exposed while it is engaged with the engagement cavity portion 12h of the receptacle housing 12. When seen from the height direction, the exposed portion 22e is formed in an approximately rectangular shape having four arc (rounded) corners and is larger than the opening 12e of the receptacle housing 12. The plug engagement wall 22g extends from the lower side of the height direction of the exposed portion 22e. When seen from the height direction, the plug engagement wall 22g is smaller than the opening 12e of the receptacle housing 12 and is formed in a shape that can be engaged with the inside of the receptacle-side outer wall portion 12a of the receptacle housing 12. In order to facilitate engagement with the receptacle-side outer wall portion 12a, the plug engagement wall 22g has a gap from the inside of the receptacle-side outer wall portion 12a. The length of the height direction of the plug engagement wall 22g is approximately equal to a length from the opening 12e of the receptacle-side outer wall portion 12a to the fixing portion 12d of the receptacle-side outer wall portion 12a. As a result, the plug-side outer wall portion 22c is engaged with the engagement cavity portion 12h until the plug engagement wall 22g abuts on the fixing portion 12d of the receptacle-side outer wall portion 12a, or the lower side of the height direction of the exposed portion 22e abuts on the opening 12e of the receptacle-side outer wall portion 12a.

The regulating portion 22d is provided inside the plug-side outer wall portion 22c to restrict a movement of the plug terminal unit 21. The regulating portion 22d is formed in a ring shape to surround a part of the circumferential surface of each plug terminal 21a. As a result, when the plug terminal unit 21 moves in a direction perpendicular to the axial direction of the plug terminal unit 21, for example, in the width direction or the depth direction, the regulating portion 22d abuts on the circumferential surface of each plug terminal 21a to restrict a movement of each plug terminal 21a. In addition, the protrusion 21e of each plug terminal 21a abuts on the regulating portion 22d from the upper side in the axial direction. As a result, when the plug terminal unit 21 moves to the lower side of the axial direction, the regulating portion 22d abuts on the protrusion 21e of each plug terminal 21a to restrict the movement of each plug terminal 21a with in predetermined position.

The lid portion 22b blocks an upper opening of the height direction of the tubular housing body 22a. The lid portion 22b is formed of an insulation member such as resin through injection molding. The lid portion 22b is formed in a flat plate shape and is installed in the upper opening of the height direction of the housing body 22a, that is, in the opening of the exposed portion 22e. The lid portion 22b restricts the upward movement of the plug terminal unit 21 in the axial direction. When the plug terminal unit 21 moves upward in the axial direction, the bolt 21c of the plug terminal unit 21 abuts on the lid portion 22b, so that the lid portion 22b restricts the movement of each plug terminal 21a.

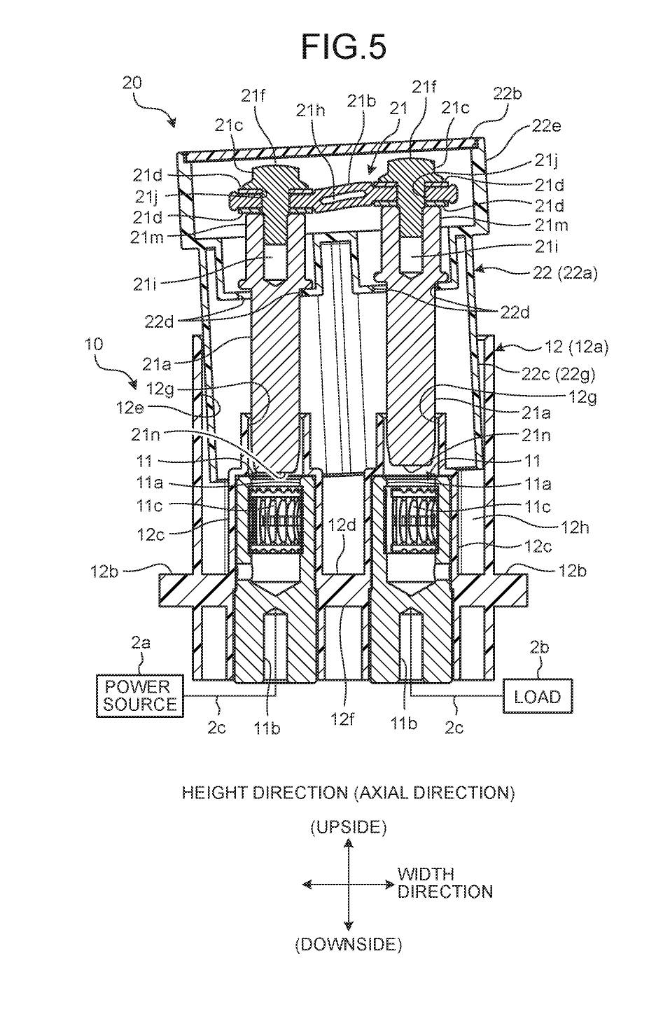

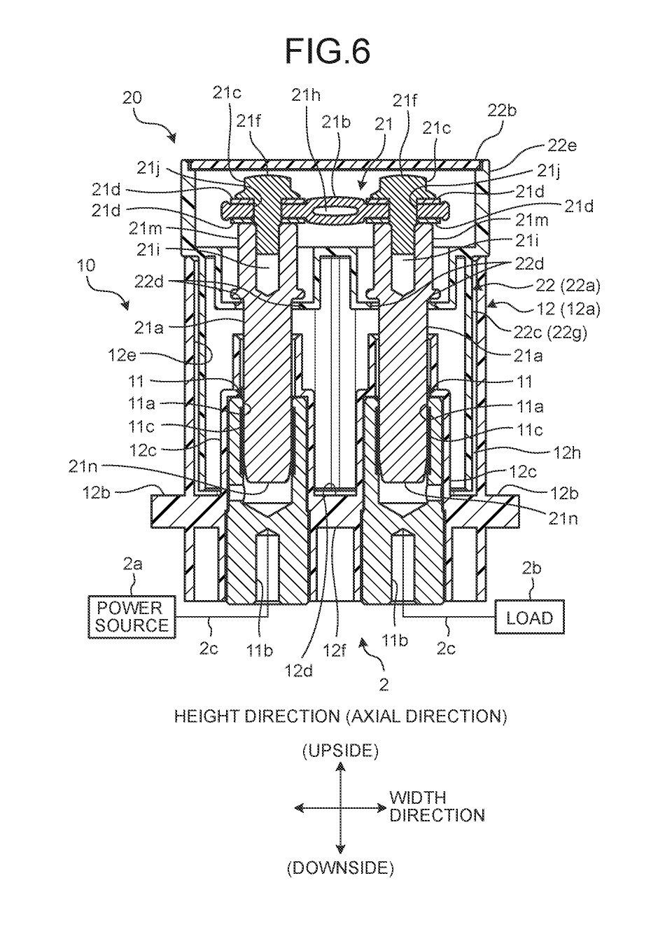

Next, functions of the plug connector 20 will be described. As illustrated in FIG. 5, the plug housing 22 of the plug connector 20 is engaged with the engagement cavity portion 12h of the receptacle housing 12. In some cases, the axial direction of the plug terminal 21a of the plug connector 20 may not be coaxial with the axial direction of the receptacle terminal 11 due to an engagement gap between the plug housing 22 and the receptacle housing 12. In this case, in the plug connector 20, when a lower end 21n of the height direction of the plug terminal 21a is inserted into the opening of the tubular holding portion 12c of the receptacle housing 12, the braided wire 21b is contracted in the width direction or is bent in the height direction, so that the plug terminals 21a move relatively to each other, and the plug terminal 21a and the receptacle terminal 11 are placed coaxially. In addition, the plug connector 20 is pushed in the engagement direction to insert the plug terminal 21a into the receptacle terminal 11 while the plug terminal 21a and the receptacle terminal 11 are placed coaxially, and the head portion 21f of the bolt 21c of the plug terminal unit 21 abuts on the lower side of the height direction of the lid portion 22b. As a result, in the plug connector 20, even when the axial direction of the plug terminal 21a is not coaxial with the axial direction of the receptacle terminal 11 during engagement, each plug terminal 21a moves relatively, and the plug terminal 21a and the receptacle terminal 11 are placed coaxially, so that the plug terminal 21a is smoothly inserted into the receptacle terminal 11. As illustrated in FIG. 6, in the plug connector 20, the plug terminal 21a is inserted into the receptacle terminal 11 and abuts on the electrode member 11c of the receptacle terminal 11, so that the plug terminal 21a and the receptacle terminal 11 are electrically connected to each other. As a result, the plug connector 20 electrically conducts the power circuit 2 along with the receptacle connector 10, so that an electric current can flow from the power source 2a to the load 2b.

When the plug connector 20 is disengaged from the receptacle connector 10, for example, due to the engagement gap between the plug housing 22 and the receptacle housing 12, the plug housing 22 may be disengaged in a sloped direction intersecting with the height direction with respect to the receptacle housing 12. In this case, in the plug connector 20, while the plug terminal 21a is inserted into the receptacle terminal 11, the plug housing 22 is pivoted against the plug terminal unit 21. That is, in the plug connector 20, even when the plug housing 22 is disengaged in a sloped direction with respect to the receptacle housing 12, only the plug housing 22 is pivoted, so that the plug connector 20 is disengaged from the receptacle connector 10 while the plug terminal 21a and the receptacle terminal 11 are placed coaxially. As a result, in the plug connector 20, even when the plug housing 22 is disengaged in a sloped direction with respect to the receptacle housing 12 during disengagement, the plug terminal 21a is smoothly removed from the receptacle terminal 11.

As described above, the plug connector 20 according to the embodiment is installed in the plug housing 22 and has the conductive braided wire 21b that connects the ends 21m of a plurality of plug terminals 21a opposite to the contact points with the receptacle terminals 11 such that each plug terminal 21a can move relatively to each other. In addition, the service plug 1 has the plug connector 20 and the receptacle connector 10. As a result, the axial direction of the plug terminal 21a is placed coaxially with the axial direction of the receptacle terminal 11 by relatively moving each plug terminal 21a during engagement between the plug connector 20 and the service plug 1, and a contact pressure between the plug terminal 21a and the receptacle terminal 11 is suppressed to a lower value. Therefore, it is possible to smoothly insert the plug terminal 21a to the receptacle terminal 11. In addition, the plug housing 22 moves relatively to the plug terminal unit 21 during disengagement between the plug connector 20 and the service plug 1, so that the plug terminal 21a can be smoothly removed from the receptacle terminal 11 while the plug terminal 21a and the receptacle terminal 11 are placed coaxially. In addition, in the plug connector 20 and the service plug 1, since the plug terminal unit 21 is not fixed to the plug housing 22 unlike the background art, it is possible to prevent insertion or removal while the plug terminal 21a is not placed coaxially with the receptacle terminal 11 due to an assembly error of the plug terminal unit 21. Furthermore, in the plug connector 20 and the service plug 1, since each plug terminal 21a is not connected to each other using a rigid member unlike the background art, it is possible to prevent each plug terminal 21a from being fixed with a different axial direction or prevent each plug terminal 21a from being fixed while each plug terminal 21a has a pitch of the width direction different from that of each receptacle terminal 11.

The braided wire 21b is formed by braiding a plurality of metal wires. As a result, the braided wire 21b is extended, contracted, or bent when the plug terminal 21a is inserted into or removed from the receptacle terminal 11 to relatively move each plug terminal 21a and coaxially place the plug terminal 21a and the receptacle terminal 11.

In the plug terminal unit 21, the head portion 21f of the bolt 21c is formed in a spherical surface shape, and the head portion 21f abuts on the inside of the plug housing 22 when the plug terminal 21a is inserted into the receptacle terminal 11. As a result, in the plug terminal unit 21, the head portion 21f of the bolt 21c can reduce resistance between the head portion 21f and the plug housing 22 caused by the slope of the bolt 21c, compared to a case where the head portion 21f has a flat shape. Therefore, in the plug terminal unit 21, the plug terminal 21a can be pushed into the receptacle terminal 11 while the plug terminal 21a and the receptacle terminal 11 are placed coaxially.

Modification

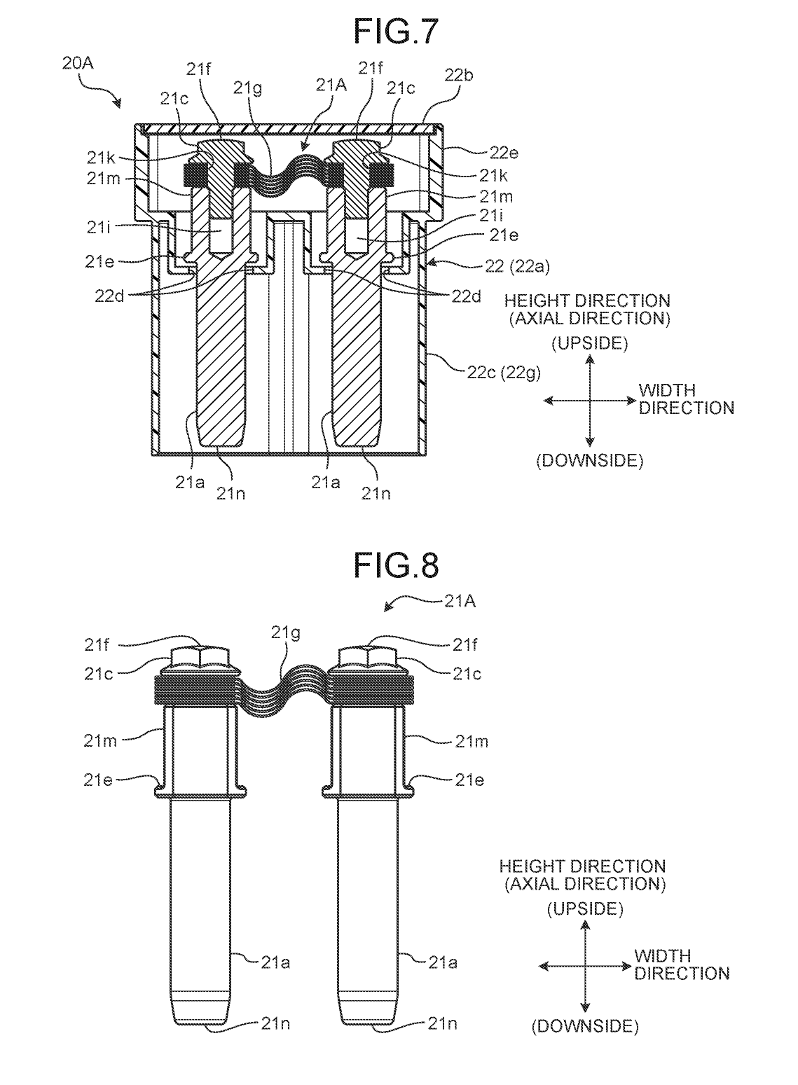

Next, a modification of the plug connector 20 according to the embodiment will be described. In the plug connector 20, the braided wire 21b is used to connect each plug terminal 21a by way of example. However, the present invention is not limited thereto. For example, as illustrated in FIGS. 7 and 8, in the plug connector 20A, a spring stack 21g connects ends 21m opposite to the contact points between each plug terminal 21a and the receptacle terminals 11. For example, the spring stack 21g is formed by stacking a plurality of metal plates with a gap and has a rectangular shape as seen from the height direction. When seen from the depth direction, a middle portion of the spring stack 21g is formed in an S-shape, and its both ends are formed in a flat shape. The spring stack 21g has holes 21k in both ends to receive the bolts 21c. The bolts 21c are fastened to the holes 21k of the spring stack 21g in both ends along with the threaded holes 21i of the plug terminal 21a to connect each plug terminal 21a.

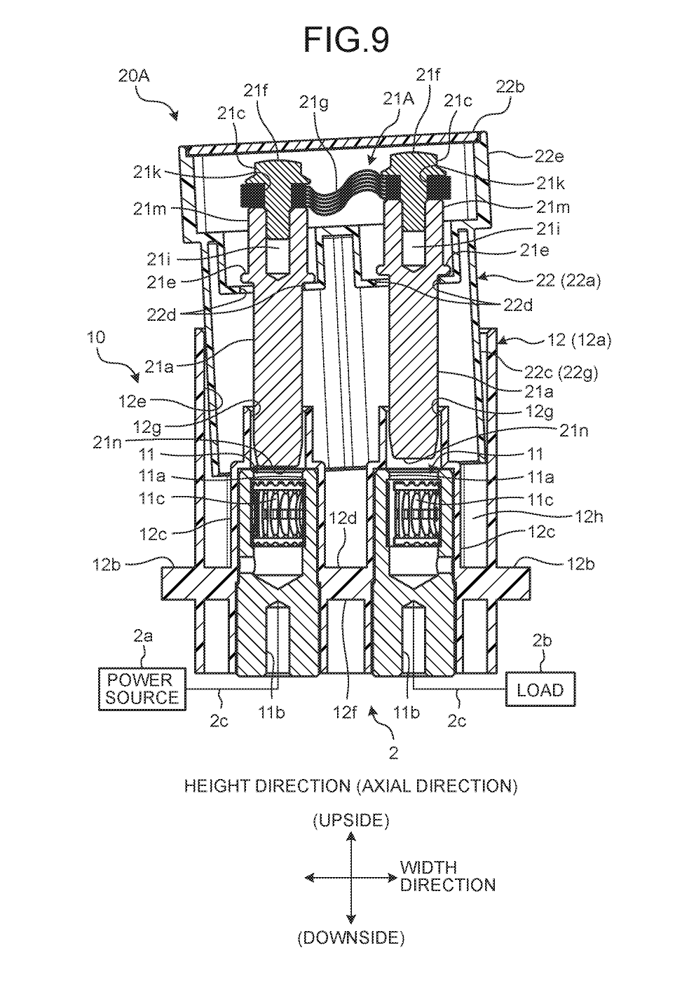

Next, functions of the plug connector 20A will be described. As illustrated in FIG. 9, in the plug connector 20A, the plug housing 22 is engaged with the engagement cavity portion 12h of the receptacle housing 12. In some cases, in the plug connector 20A, the axial direction of the plug terminal 21a may not be placed coaxially with the axial direction of the receptacle terminal 11 due to an engagement gap between the plug housing 22 and the receptacle housing 12. In this case, in the plug connector 20A, when the lower end 21n of the height direction of the plug terminal 21a is inserted into the opening 12g of the tubular holding portion 12c of the receptacle housing 12, the spring stack 21g is extended or contracted in the width direction or is bent in the height direction, so that each plug terminal 21a moves relatively to each other, and the plug terminal 21a and the receptacle terminal 11 are placed coaxially. In addition, the plug connector 20A is pushed in the engagement direction while the plug terminal 21a and the receptacle terminal 11 are placed coaxially, and the head portion 21f of the bolts 21c of the plug terminal unit 21A abuts on the lower side of the height direction of the lid portion 22b, so that the plug terminal 21a is inserted into the receptacle terminal 11. As a result, in the plug connector 20A, even when the axial direction of the plug terminal 21a is not placed coaxially with the axial direction of the receptacle terminal 11 during engagement, each plug terminal 21a moves relatively, and the plug terminal 21a and the receptacle terminal 11 are placed coaxially, so that the plug terminal 21a is smoothly inserted into the receptacle terminal 11.

In the plug connector 20A, when the receptacle connector 10 is disengaged, for example, due to the engagement gap between the plug housing 22 and the receptacle housing, the plug housing 22 may be disengaged in a sloped direction intersecting with the height direction with respect to the receptacle housing 12 in some cases. In this case, in the plug connector 20A, while the plug terminal 21a is inserted into the receptacle terminal 11, the plug housing 22 is pivoted with respect to the plug terminal unit 21A. That is, in the plug connector 20A, even when the plug housing 22 is disengaged in a sloped direction with respect to the receptacle housing 12, only the plug housing 22 is pivoted. Therefore, the plug housing 22 is disengaged from the receptacle connector 10 while the plug terminal 21a and the receptacle terminal 11 are placed coaxially. As a result, in the plug connector 20A, the plug terminal 21a is smoothly removed from the receptacle terminal 11 even when the plug housing 22 is disengaged in a sloped direction with respect to the receptacle housing 12 during disengagement.

As described above, in the plug connector 20A according to the modification, the spring stack 21g is formed by stacking a plurality of metal plates. As a result, in the plug connector 20A, the spring stack 21g is extend or contracted in the width direction or is bent in the height direction when the plug terminal 21a is inserted into or removed from the receptacle terminal 11, so that the plug terminal 21a and the receptacle terminal 11 can be placed coaxially by relatively moving each plug terminal 21a.

The service plug 1 may be a lever type connector having a lever pivotally provided in the plug housing 22 to exert an engagement of disengagement force between the plug housing 22 and the receptacle housing 12 through a pivoting control.

In the service plug 1, the plug terminal 21a is a male terminal, and the receptacle terminal 11 is a female terminal. However, the present embodiment is not limited thereto. For example, in the service plug 1, the plug terminal 21a may be a female terminal, and the receptacle terminal 11 may be a male terminal.

The plug connector and the power circuit cut-off device according to the present embodiment have the conductive wire member that connects the plug terminals such that each plug terminal can move relatively to each other. Therefore, it is possible to smoothly insert or remove the plug terminal and the receptacle terminal by relatively moving each plug terminal and coaxially placing the plug terminal and the receptacle terminal.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A plug connector comprising:
a housing engaged with or disengaged from a receptacle connector for performing electrical connection; and
a plug terminal unit that is provided in the housing, and has a plurality of bar-shaped plug terminals inserted into or removed from receptacle terminals of the receptacle connector in an axial direction, and a conductive wire member that connects ends of the plurality of plug terminals opposite to contact points with the receptacle terminals such that each plug terminal can move relatively to each other, wherein
the plurality of plug terminals and the wire member constitute a part of a power circuit for supplying electric power from a power source to a load along with the receptacle terminals, and
the plurality of plug terminals electrically conduct the power circuit while the plug terminals are connected to the receptacle terminals.

2. The plug connector according to claim 1, wherein
the wire member is a braided wire formed by braiding a plurality of metal wires or a spring stack formed by stacking a plurality of metal plates.

3. The plug connector according to claim 1, wherein
the plug terminal unit has a fastening member configured to fasten the ends opposite to contact points with the receptacle terminals to the wire member,
a head portion of the fastening member is formed in a spherical surface shape, and
the head portion of the fastening member abuts on an inside of the housing when the plug terminals are inserted into the receptacle terminals.

4. The plug connector according to claim 2, wherein
the plug terminal unit has a fastening member configured to fasten the ends opposite to contact points with the receptacle terminals to the wire member,
a head portion of the fastening member is formed in a spherical surface shape, and
the head portion of the fastening member abuts on an inside of the housing when the plug terminals are inserted into the receptacle terminals.

5. A power circuit cut-off device comprising:
a receptacle connector having a receptacle terminal for performing electrical connection; and
a plug connector having a housing engaged with or disengaged with the receptacle connector, and a plug terminal unit that is provided in the housing and has a plurality of bar-shaped plug terminals inserted into or removed from receptacle terminals of the receptacle connector in an axial direction, and a conductive wire member that connects ends of the plurality of plug terminals opposite to contact points with the receptacle terminals such that each plug terminal can move relatively to each other, wherein
the plurality of plug terminals and the wire member constitute a part of a power circuit for supplying electric power from a power source to a load along with the receptacle terminals, and
the plurality of plug terminals electrically conduct the power circuit while the plug terminals are connected to the receptacle terminals.
